(19) United States
(12) Patent Application Publication
(10) Pub. No.: US 2026/0326413 A1
(43) Pub. Date: Oct. 22, 2026

(54) A FLEXIBLE INSULATING MEMBER

(71) Applicant: Cabot Corporation, Boston, MA (US)

(72) Inventors: Clare Bannon, Boston, MA (US); Xiaofeng Zhang, Shrewsbury, MA (US); Sean S. Sullivan, Lynn, MA (US); Jeffrey W. Gamble, North Andover, MA (US)

(21) Appl. No.: 19/484,744

(22) PCT Filed: Jun. 4, 2024
(86) PCT No.: PCT/US2024/032349

§ 371 Date: Nov. 14, 2025

Related U.S. Application Data
(60) Provisional application No. 63/506,144, filed on Jun. 5, 2023.

(51) Int. Cl. B32B 5/26; B32B 5/24; B32B 7/10; H01M 10/658

(52) U.S. Cl. CPC B32B 5/262; B32B 5/245; B32B 5/265; B32B 7/10; H01M 10/658; B32B 2266/126; B32B 2307/304; B32B 2307/3065; B32B 2307/54; B32B 2307/7376; B32B 2457/10

(57) ABSTRACT

A flexible insulating member is described. The insulating member can be a single layer or can include a first layer having aerogel and a first fibrous component, and a second layer that is a mat having a second fibrous component. The first layer and second layer are adhered together. The flexible insulating member is non-flammable per UL94 V0 and has a thermal conductivity at 25° C. of less than 40 mW/m·K, and has a thickness of at least 0.3 mm. Methods of making the insulating member are further described along with uses for the insulating member.

### BACKGROUND OF THE INVENTION

The present invention relates to the use of aerogels in products and methods to make the same. More specifically, the present invention relates to flexible insulating members that can be single or multi-layer flexible insulating members, such as blankets, that utilize aerogel in at least a part of the insulating member.

Aerogel particles can have a very low density, high porosity, and small pore diameters. Aerogels, and in particular silica aerogels, exhibit low density and low thermal conductivity, making them useful as insulative materials. Aerogels can be formed by removing solvent from hydrogels, such as through supercritical drying techniques or via solvent substitution combined with ambient pressure drying. Silica aerogels are typically hydrophilic but can be rendered hydrophobic through the use of specific treating agents.

In the broadest sense, i.e., when regarded as “gels with air as the dispersant,” aerogels are manufactured by drying a suitable gel. When used in this sense, the term “aerogel” includes aerogels in the narrower sense, such as xerogels and cryogels. A gel is designated as an aerogel in the narrower sense if the liquid is removed from the gel at temperatures above the critical temperature and starting from pressures that are above the critical pressure. In contrast to this, if the liquid is removed from the gel sub-critically, for example with the formation of a liquid-vapor boundary phase, then the resulting gel is, in many instances, referred to as xerogel. It should be noted that the gels according to the present invention are aerogels in the sense that they are gels with air as the dispersing media.

Due to their excellent insulating properties, aerogels have been incorporated in various types of articles, including heat control members (sheets, pads or blankets, for example) designed for applications such as construction, refrigeration, pipe transport and others. One application of increased interest relates to the insulation of rechargeable batteries in electrical vehicles (EV).

The automotive industry is shifting from conventional Internal Combustion Engine (ICE) powertrains to battery powered Electrical Vehicles (EV) to reduce global greenhouse gas emissions. EVs are utilizing electrochemical energy storage systems or batteries instead of burning fossil fuels (gasoline or diesels) as the source of energy. The most well-adopted technology for EV batteries is based on Li-ion chemistry, which typically consists of cathode and anode separated by separators and electrolyte. Li-ion batteries offer a good balance of energy density, power density and cycle life which makes it the most suitable system to provide electricity for EV. However, Li-ion battery can undergo thermal runaway in abuse conditions, which may cause fire and explosion of the battery and thus put passengers' lives at risk. Regulatory standards such as GTR20, already in place for EVs, require that if thermal runaway occurs, the vehicle shall provide at least 5 minute warning or egress time prior to the presence of a hazardous situation within the cabin.

Many technical pathways have been pursued to prevent or reduce the thermal runaway hazards, from cell level to pack level, up to car level. Once the thermal runaway event is triggered, the heat releases from the cell undergoing such event; alternatively, the thermal runaway event can trigger propagation to the adjacent cell and cause the so-called thermal runaway propagation, which can escalate the hazard.

Therefore, one effective solution to address this hazard is to install a thermal barrier between the battery cells to reduce thermal runaway propagation from the trigger cell to the neighboring cells. The thermal barrier can be aerogel/glass fiber blanket, ceramic paper, or silicone foam with a thermal conductivity in the range of 15-100 mW/m·K at room temperature. A lower thermal conductivity is always desired as it will further reduce heat propagation by conduction between the hot trigger cell to the neighboring cell at a lower temperature.

Silica-based aerogel particle products are excellent thermal insulation additives and can be used in various product forms, including papers, coatings, plasters, boards and blankets, and they can be used in a variety of industrial applications. Silica aerogel is light in weight and a good insulating solid. With a thermal conductivity of about 10-45 mW/m·K at room temperature; it is considered to be the only solid material with better insulating properties than still air.

However, even in view of the above, one challenge in the industry is providing a product that is sufficiently thin for applications such as for a thermal barrier for battery cells. But, with thinness comes a potential undesirable drop in thermal and/or flame properties. Further, the manufacturing of a thin product has many challenges especially in a wet laid formation process.

Accordingly, there is a need to provide a flexible insulating member that can be produced to have a minimal overall thickness and yet achieve the desired properties as a thermal barrier for various applications, and especially as a thermal barrier for battery cells in electric vehicles.

### SUMMARY OF THE INVENTION

A feature of the present invention is to provide a thermal barrier that is useful in such applications as a thermal barrier for vehicle battery cells.

A further feature of the present invention is to provide a thermal barrier that can be made thin and yet retain desirable thermal barrier properties.

An additional feature of the present invention is to provide a thermal barrier that can be flexible and be made in a wet laid process.

Also, a feature of the present invention is to provide a flexible thermal barrier that is non-flammable and preferably maintains the thermal barrier properties.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a flexible insulating member that includes a layer that is a mat. The mat includes at least a second fibrous component. A pre-formed aerogel is dispersed or otherwise present in the mat. The layer that is a mat also has a first fibrous component dispersed therein. The flexible insulating member is non-flammable per UL94 V0 and has a thermal conductivity at 25° C. of less than 40 mW/m·K, and has a thickness of at least 0.3 mm.

The present invention, in addition, relates to a multi-layer flexible insulating member. The insulating member includes a first layer and a second layer. The first layer includes aerogel and a first fibrous component, and the second layer includes a mat that includes at least a second fibrous component. The first layer and second layer are affixed together to form a multi-layer member. The multi-layer flexible insulating member is non-flammable per UL94 V0 and has a thermal conductivity at 25° C. of less than 40 mW/m·K, and has a thickness of at least 0.3 mm.

The present invention further relates to a method of making the multi-layer flexible insulation member of the present invention. The method includes forming a wet laid layer (i.e., the first layer), on the second layer and then drying the multi-layer member.

It is to be understood that both the foregoing general description and the following detailed description are exemplary and explanatory only and are intended to provide a further explanation of the present invention, as claimed.

The accompanying drawings, which are incorporated in and constitute a part of this application, illustrate some of the embodiments of the present invention and together with the description, serve to explain the principles of the present invention.

### BRIEF DESCRIPTION OF DRAWINGS

FIG. 1 is a blown-up side view of one example of the flexible insulating member of the present invention, which is multi-layer and where there is slight intermeshing or intermixing of the first layer with the second layer.

FIG. 2 is a blown-up side view of another example of the flexible insulating member of the present invention, which is multi-layer and where there is more intermeshing or intermixing of the first layer (approx. 10% to 50%) with the second layer to define a region of intermeshing or penetration.

FIG. 3 is a blown-up side view of another example of the flexible insulating member of the present invention, which is multi-layer and where there is even more intermeshing or intermixing of the first layer (approx. 50% to 90%) with the second layer to define a region of intermeshing or penetration.

FIG. 4 is a blown-up side view of a further example of the flexible insulating member of the present invention, which is single layer and where the aerogel and first fibrous component are fully intermeshed or embedded or penetrated into the upper portion of the mat.

FIG. 5 is a blown-up side view of a further example of the flexible insulating member of the present invention, which is single layer and where the aerogel and first fibrous component are fully intermeshed or embedded or penetrated into essentially the entire thickness of the mat.

### DETAILED DESCRIPTION

The present invention relates to insulating members that include aerogel, such as aerogel particles. The present invention further relates to flexible insulating members that include aerogel. Further, the present invention relates to multi-layer flexible insulating members that include aerogel in at least one of the layers. Methods of making the insulating members is further set forth herein as well as uses for the insulating members.

At least one aspect of the present invention accordingly relates specifically to a single layer insulating member. While the single layer is referred to as a ‘mat’ herein, the flexible insulating member, for example, can be a blanket, sheet, pad, mat and the like.

At least one further aspect of the present invention relates specifically to a multi-layer insulating member where the second layer is referred to as a ‘mat’, but it is understood that this second layer and in fact the overall flexible insulating member in any of the embodiments of the present invention can be, for example, a blanket, sheet, pad, mat, and the like.

Further, at least one aspect of the present invention accordingly relates specifically to a multi-layer flexible insulating member. The multi-layer flexible insulating member, for example, can be a blanket, sheet, pad, mat and the like.

The insulating member comprises, consists essentially of, consists of, or includes at least a first layer or a single layer. The insulating member, as an option, only includes a first layer and no other additional layers (i.e., a single-layer flexible insulating member).

As another option, the insulating member comprises, consists essentially of, consists of, or includes at least a first layer and a second layer. The insulating member, as an option, only includes a first layer and a second layer and no other additional layers (i.e., a two-layer flexible insulating member).

As indicated, as one option, the present invention relates to a flexible insulating member that includes a layer (e.g., a single layer) that is a mat. The mat includes at least a second fibrous component and a pre-formed aerogel. The layer that is a mat also has a first fibrous component dispersed therein. The flexible insulating member is non-flammable per UL94 V0 and has a thermal conductivity at 25° C. of less than 40 mW/m·K, and has a thickness of at least 0.3 mm.

The flexible insulating member further has a thickness of at least 0.3 mm. This can be an average thickness. Alternatively, this can be a maximum thickness. The thickness can be at least 0.4 mm or at least 0.5 mm. The thickness can be from 0.3 mm to 10 mm, or from 0.3 mm to 9 mm, or from 0.3 mm to 8 mm, or from 0.3 mm to 7 mm, or from 0.3 mm to 6 mm, or from 0.3 mm to 5 mm, or from 0.3 mm to 4 mm, or from 0.3 mm to 3 mm, or from 0.3 mm to 2 mm, or from 0.4 mm to 10 mm, or from 0.5 mm to 10 mm or from 0.6 mm to 10 mm, or from 0.3 mm to 1.5 mm, or from 0.5 mm to 1.5 mm or higher. The thickness can be from 0.5 mm to 1.25 mm, from 0.5 mm to 1 mm, from 0.5 mm to 0.75 mm. The thickness can be above 1.5 mm for certain applications if desired (e.g., 1.5 mm to 5 mm or 1.5 mm to 10 mm). Preferably, in certain applications, the overall average thickness of the multi-layer flexible insulating member is below 1.5 mm, or below 1.25 mm, or below 1 mm, or below 0.75 mm or below 0.5 mm or any range based upon any two values described herein.

Examples of a flexible insulating member of the present invention include, but are not limited to, a blanket, a mat, a pad, or a sheet, or other articles.

The mat can be considered a fiber mat or fibrous mat. The mat, for purposes of the present invention, can be considered a mat or a fabric. A ‘fiber mat’ is considered a ply of chopped (short and/or long) yarns/fibers that are held together by binder and/or stitches. A ‘fiber fabric’ is considered a ply of continuous yarns/fibers manufactured by laminating techniques, such as weaving or knitting. For purposes of the present invention, the ‘mat containing a second fibrous component’ can be either a fiber mat or fiber fabric. The mat preferably, itself, meets the non-flammable rating of UL-94 V0.

Examples of the mat include, but are not limited to, a chopped strand mat, a continuous filament random mat, a veil mat, a continuous strand fiber mat, a continuous strand veil surfacing mat, a woven fabric mat, a non-crimp fabric mat. The mat can be or include mica laminated paper layer(s), rock wool layer(s), slag wool layer(s), alumina silica layer(s), graphite fiber layer(s), mineral wool fiber layer(s), silicone rubber sheeting layer(s), silica fiber layer(s), glass fiber layer(s), carbon fiber layer(s), e-glass cloth silicon coated ceramic paper layer(s), aerogel mat layer(s), polyamide paper layer(s), or any combinations thereof. One preferred mat can be, for instance, a fiberglass mat.

The mat can be a medium density fiber mat. The mat can be a high density fiber mat. The second layer can be a woven layer or a non-woven layer.

The mat can be considered to be or include a woven mat or a non-woven mat.

Commercially available mats that can be used include continuous strand veil surfacing mats or continuous strand mats, such as, but not limited to FIBREGLAST mats (e.g., FIBREGLAST 260 mat) or other fiberglass mats.

The mat itself (prior to the pre-formed aerogel and first fibrous component being dispersed therein) can be porous and/or has random openings or voids. The porosity or openings or voids can encompass at least 5% of the total volume of the second layer, such as at least 10%, at least 15%, or from 5% to 20% of the total volume of the mat.

Details of the aerogel and details of the first fibrous component as well as optional components are described in detail below for the multi-layer insulating member and apply equally in this embodiment.

With respect to the flexible insulating member that is a single layer, the aerogel is pre-formed before being dispersed in the mat, and is not formed in-situ in the mat. By doing so, the aerogel particles are maintained in their shape and size for the most part, and are dispersed in the mat.

The aerogel particles, once dispersed in the mat, can be considered non-uniformly dispersed throughout the mat. In other words, the distribution of aerogel particles throughout the mat is not uniform and can vary in different sections of the mat. Thus, one section of the mat can have an aerogel density that is different by at least 5%, at least 10%, at least 15%, at least 20%, at least 25% or more compared to other sections of the same mat.

The aerogel particles, once dispersed in the mat, and because the aerogel particles are pre-formed before dispersing, preferably do not coat the fibers present in the mat. If a comparison of in-situ formed aerogel particles with pre-formed aerogel particles is made, the average particle size or the D10 or the D90 size distribution of the pre-formed aerogel particles can generally be quite different. For instance, the D90 can be at least 10%, or at least 20%, or at least 30% higher in value for the pre-aerogel particles in the mat compared to in-situ aerogel particles.

In this embodiment with a single layer, the dispersing of the aerogel and first fibrous component can be done by casting or pouring or otherwise dispersing a slurry of aerogel and first fibrous component (that is the slurry is preferably flocculated) and this fills or occupies the voids or openings or porosity, at least in part, that exists in the mat. This can be further characterized as follows, as an option. The flexible insulating member is such that the mat has a thickness and a porosity throughout the thickness, and the aerogel and first fibrous component fills/occupies at least 50% of the porosity throughout at least 90% of the thickness of the mat.

The flexible insulating member can be further or alternatively characterized such that the mat (dried) has an air permeability itself, and the air permeability is reduced by at least 50% after the pre-formed aerogel and a first fibrous component dispersed therein and the member is dried. The reduction can be at least 60%, at least 70%, at least 80%, at least 90%, at least 95%, such as from 50% to 99% or from 50% to 90%.

As an option, in the flexible insulating member, the pre-formed aerogel and a first fibrous component can completely disperse below a top surface of the mat. Thus, when observing the mat's exposed top surface, the aerogel and first fibrous component are not observable or occupy less than 20% of the cross-section exposed top surface of the mat (e.g., less than 15%, less than 10%, less than 5%, less than 1%).

In a further embodiment of the present invention, the multi-layer insulating member is described in further detail.

The first layer comprises, consists essentially of, consists of, or includes aerogel and a first fibrous component. The first layer can be manufactured by a wet laid technique from a composition (e.g., slurry) that contains aerogel particles and the first fibrous component with optional one or more other materials.

The second layer comprises, consists essentially of, consists of, or includes a mat. The mat comprises, consists essentially of, consists of, or includes a second fibrous component.

In the multi-layer flexible insulating member of the present invention, the first layer and second layer are affixed together.

The flexible insulating member (e.g., the single layer or multi-layer flexible insulating member) further is non-flammable per UL94 V0 (i.e., meets or satisfies UL 94 V0).

The flexible insulating member (e.g., the single layer or multi-layer flexible insulating member) further has a thermal conductivity at 25° C. of less than 40 mW/m·K. The thermal conductivity at 25° C. can be less than 35 mW/m·K, or less than 30 mW/m·K, or less than 25 mW/m·K, or less than 20 mW/m, or less than 15 mW/m·K, or less than 10 mW/m·K, or from 1 mW/m·K to 39 mW/m·K or any range based upon any two values described herein.

The multi-layer flexible insulating member further has a thickness of at least 0.3 mm. This can be an average thickness. The thickness can be at least 0.4 mm or at least 0.5 mm. The thickness can be from 0.3 mm to 10 mm, or from 0.3 mm to 9 mm, or from 0.3 mm to 8 mm, or from 0.3 mm to 7 mm, or from 0.3 mm to 6 mm, or from 0.3 mm to 5 mm, or from 0.3 mm to 4 mm, or from 0.3 mm to 3 mm, or from 0.3 mm to 2 mm, or from 0.4 mm to 10 mm, or from 0.5 mm to 10 mm or from 0.6 mm to 10 mm, or from 0.3 mm to 1.5 mm, or from 0.5 mm to 1.5 mm or higher. The thickness can be from 0.5 mm to 1.25 mm, from 0.5 mm to 1 mm, from 0.5 mm to 0.75 mm. The thickness can be above 1.5 mm for certain applications if desired (e.g., 1.5 mm to 5 mm or 1.5 mm to 10 mm). Preferably, in certain applications, the overall average thickness of the multi-layer flexible insulating member is below 1.5 mm, or below 1.25 mm, or below 1 mm, or below 0.75 mm or below 0.5 mm or any range based upon any two values described herein.

Examples of a flexible insulating member of the present invention include, but are not limited to, a blanket, a mat, a pad, or a sheet, or other articles.

The first layer and second layer can be affixed together such that the two layers cannot be easily pulled apart, for instance, by hand. The affixing of the first layer to the second layer can be considered an interweaving or interpenetration of at least portions of the surface of the first layer that contacts the surface of the second layer. The force to peel the two layers apart can be a force of at least 0.5 N or at least 1 N or at least 1.5 N or at least 2 N. The peeling force can be measured following ASTM D751-06 (180 degree test). The adhered layers can have an average peeling force of at least 0.1 kgf/cm³, such as from 0.1 to 5 4 kgf/cm³, or from 0.3 to 4.5 4 kgf/cm³, or from 0.5 to 4 kgf/cm³ or any range based upon any two values described herein.

The first layer and the second layer can, for instance, be affixed together by portions of the first layer penetrating or entangling or embedding with portions of the second layer. For example, the first layer and the second layer can be affixed together by calendaring, or can be affixed together by point bonding. Alternatively or additionally, the affixing of the two layers can be achieved or include chemical adhesion of portions of the first layer with portions of the second layer. For instance, a portion of a binder present in at least one of the layers can provide adherence to the other layer. As another example, the formation of the first layer on the second layer by a wet laid technique (e.g., pouring of a slurry of a composition that forms the first layer) can, in and of itself, achieve sufficient affixing to the second layer once the first layer is formed and dried, due to portions of the first layer penetrating portions of the second layer and due to affixing and/or adhesion that occurs from the drying of one layer on another.

As an option, the affixing of the first layer to the second layer can be achieved in the absence of any chemical adhesive on the layers. As an option, the first layer and the second layer can be affixed together in the absence of a separate adhesive layer.

As an option, two or more of the flexible insulating members (e.g., the single layer or multi-layer flexible insulating member) can be affixed or stacked on top of each other. When more than one flexible insulating member of the present invention is affixed or stacked together, each of the flexible insulating members can be the same or different from each other with respect to thickness and/or components that form each of the respective insulating members. The stacked or insulating member can have an overall average thickness of from 0.6 mm to 10 mm or 0.6 mm to 20 mm, or 0.6 mm to 30 mm. The stacking or affixing of insulating members to form an article can be achieved in one of the manners described with respect to the affixing of the first layer to the second layer to form one insulating member.

As an option, in the multi-layer flexible insulating member, the first layer, in part, penetrates or saturates into the second layer such that at least a portion of the multi-layer flexible insulating member comprises the mat with the aerogel and the first fibrous component intermeshed together to define a region in the multi-layer flexible insulating member.

The region can be from 1/10 to ¼ of an upper (top) part of the second layer. The region can be from ¼ to ½ of an upper part of the second layer. The region can be from ½ to ¾ of an upper part of the second layer. The region can be from ¾ to ⅞ of an upper part of the second layer.

The flexible insulating member (e.g., the single layer or multi-layer flexible insulating member) can have a tensile strength of at least 10 N. The tensile strength can be from about 10 N to 90 N, or from about 10 N to 80 N, or from about 10 N to 70 N, or from about 15 N to 70 N, or from about 20 N to 70 N, or from about 30 N to 70 N, or from about 40 N to 70 N, or from about 10 N to 60 N, or from about 10 N to 50 N, or from about 10 N to 40 N, or any range based upon any two values described herein. The tensile strength can be considered ultimate tensile strength. The tensile strength can be an average tensile strength. The tensile strength can be measured per ASTM D828 Standard test method for tensile properties using constant-rate-of-elongation apparatus.

The aerogel in the single layer or in at least the first layer can be any type of aerogel. The aerogel can be particulates of aerogel. The aerogel can be aerogel particles.

The aerogel can be silica aerogel particles and/or hydrophobic silica aerogel particles.

The aerogel can be surface modified using surface modifiers.

The aerogel in the first layer can be evenly or uniformly distributed throughout the first layer.

The aerogel particles can have a particle size in a range of from 0.1 mm to 5 mm, for example, from 0.1 mm to 4 mm, from 0.1 mm to 1.5 mm, from 0.5 mm to 4 mm, or from 1 mm to 4 mm. Further details of the aerogel are provided below in later sections. Aerogel particle size range may be determined by sieving.

The aerogel utilized in the first layer or in the single layer can be characterized itself by one or more properties. For instance, the aerogel (e.g., aerogel particles) can have porosities greater than about 60% and densities of less than about 0.4 g/cc, or densities of from about 0.05 to about 0.15 g/cc.

The aerogel utilized can have a thermal conductivity of less than about 40 mW/m. K, less than about 25 mW/m. K, or from about 12 mW/m. K to about 18 mW/m. K, or lower. Thermal conductivity can be measured as set forth in the examples.

The aerogel utilized can have a caloric content of less than 10 MJ/kg, less than 8 MJ/kg, less than 7 MJ/kg or less than 6 MJ/kg. Caloric content can be measured with a bomb calorimeter or other apparatus known to those skilled in the art to make such measurements. A method such as ASTM E711-87 can be utilized.

As a further option, all components that form the aerogel slurry that is dispersed in the mat or that are the first layer can be part of a flocculated mixture that results in a flocculated wet laid resulting in a flocculated layer or a flocculated aerogel composition dispersed in the layer.

The first fibrous component of the first layer can be evenly or uniformly distributed throughout the first layer. As an option, the first fibrous component can be non-uniformly distributed throughout the first layer.

The first fibrous component along with the aerogel of the first layer can be evenly or uniformly distributed together throughout the first layer, such that the distribution of each component is about the same throughout the first layer (e.g., a variance of less than 10 wt % or less than 5 wt % or less than 1 wt % of each component).

The first fibrous component can be one type of fiber or combinations of two or more types of fibers.

The fiber(s) can be synthetic fibers and/or natural fibers. The fibers can be polymer fibers or inorganic fibers. The fibers can be one or more of the following: polyester fibers, rayon fibers, spandex fibers, acrylic fibers, metallic fibers, glass fibers, ceramic fibers, carbon fibers, rubber fibers, cellulose fibers, lyocell fibers, triacetate fibers, acetate fibers, polyolefin fibers, and/or microfibers of any of the fibers mentioned herein.

Examples of the first fibrous component include, but are not limited to, a glass based fiber, a ceramic fiber, a ceramic wool and/or a polymeric fiber. Examples of a ceramic wool include a zirconium-containing ceramic wool or a mineral wool. The polymeric fiber can be temperature resistant polymeric fibers such as aramid and/or polybenzimidazole (PBI) fibers. These materials can represent the entire fibrous component or can be used in combination with ceramic fibers (e.g., alumina-silica ceramic fibers). In some cases, the ceramic wool, polymer fibers such as aramid and/or polybenzimidazole fibers, and/or their combinations are provided in amounts that are less than 50% relative to the weight of the entire fibrous component in the first layer.

The first fibrous component can be present in an amount of at least 10 wt %, such as from 10 wt % to 90 wt %, based on the total dry weight of the first layer. This amount can be from 20 wt % to 80 wt %, from 30 wt % to 70 wt %, from 40 wt % to 70 wt %, from 50 wt % to 90 wt %, from 60 wt % to 90 wt %, from 10 wt % to 30 wt %, from 10 wt % to 40 wt % or any range based upon any two values described herein.

The amount of aerogel and the amount of the first fibrous component can be characterized as a weight ratio. The aerogel to fiber weight ratio can be from 10:1 to 1:10 (based on a dry weight). This weight ratio can be from 10:1 to 9:1 or from 10:1 to 8:1, or from 10:1 to 7:1, or from 10:1 to 6:1, or from 10:1 to 5:1, or from 10:1 to 4:1, or from 10:1 to 3:1, or from 10:1 to 2:1, or from 10:1 to 1:1, or from 1:10 to 1:9, or from 1:10 to 1:8, or from 1:10 to 1:7, or from 1:10 to 1:6, or from 1:10 to 1:5, or from 1:10 to 1:4, or from 1:10 to 1:3, or from 1:10 to 1:2 or any range based upon any two values described herein.

In other embodiments, the composition (that forms the single layer or first layer or second layer) can include rubber particles, such as silicone rubber particles. These particles can be used in conjunction with conventional ceramic fibers and/or the wool and/or polymeric fibers (e.g., PBI, aramid) described herein.

Regarding the second layer, the mat is the second layer or at least is part of the second layer.

The mat can be considered a fiber mat or fibrous mat. The mat, for purposes of the present invention, can be considered a mat or a fabric. A ‘fiber mat’ is considered a ply of chopped (short and/or long) yarns/fibers that are held together by binder and/or stitches. A ‘fiber fabric’ is considered a ply of continuous yarns/fibers manufactured by laminating techniques, such as weaving or knitting. For purposes of the present invention, the ‘mat containing a second fibrous component’ can be either a fiber mat or fiber fabric. The mat preferably, itself, meets the non-flammable rating of UL-94 V0.

Examples of the mat include, but are not limited to, a chopped strand mat, a continuous filament random mat, a veil mat, a continuous strand fiber mat, a continuous strand veil surfacing mat, a woven fabric mat, a non-crimp fabric mat. The mat can be or include mica laminated paper layer(s), rock wool layer(s), slag wool layer(s), alumina silica layer(s), graphite fiber layer(s), mineral wool fiber layer(s), ceramic wool layer(s), ceramic fiber layer(s), silicone rubber sheeting layer(s), silica fiber layer(s), glass fiber layer(s), carbon fiber layer(s), e-glass cloth silicon coated ceramic paper layer(s), aerogel mat layer(s), polyamide paper layer(s), or any combinations thereof. One preferred mat can be, for instance, a fiberglass mat.

The mat can be a medium density fiber mat. The mat can be a high density fiber mat. The second layer can be a woven layer or a non-woven layer.

The second layer can be considered to be or include a woven mat or a non-woven mat.

Commercially available mats that can be used include continuous strand veil surfacing mats or continuous strand mats, such as, but not limited to FIBREGLAST mats (e.g., FIBREGLAST 260 mat) or other fiberglass mats.

The single layer or the second layer can be porous and/or has random openings or voids. The porosity or openings or voids can encompass at least 5% of the total volume of the second layer, such as at least 10%, at least 15%, at least 25%, at least 35%, at least 50%, at least 60%, at least 70%, at least 80%, at least 90%, at least 95%, such as from 5% to 99%, or from 5% to 20%, or from 50% to 99%, or from 25% to 95%, or from 40% to 80%, or from 60% to 95%, or from 70% to 90% of the total volume of the second layer.

The single layer or the second layer can have at least a thickness in portions of the second layer that is from 0.2 mm to 0.5 mm or higher. This thickness can be a maximum thickness measurement or can be an average thickness measurement. The second layer can vary with respect to thickness throughout the cross-sectional area. The thickness can be from 0.2 mm to 0.4 mm, or from 0.2 mm to 0.3 mm. The average thickness or maximum thickness of the second layer can be from about 0.5 mm to 2 mm or from 0.5 mm to 1 mm, or from 0.5 mm to 0.75 mm or any range based upon any two values described herein.

The mat of the second layer can comprise several mats stacked or adhered or otherwise connected together to form the mat of the second layer. When multiple mats are used, the mats can be the same or different from each other.

The mat of the single layer or second layer can contain binder(s) and/or other components. The amount can be at least 1 wt % based on the weight of the mat, such as from 1 wt % to 10 wt % or more, from 2 wt % to 15 wt %, from 5 wt % to 10 wt %, from 6 wt % to 15 wt %, or any range based upon any two values described herein. A layer of a multi-layer or the single layer, or all layers can optionally not have any binder present.

Further details and options for the single layer or the first layer are provided. The first layer can further comprise or include at least one binder. The binder is generally evenly distributed throughout the layer. The aerogel to binder weight ratio can be from 70:1 to 1:1 or from 60:1 to 1:1, or from 50:1 to 1:1 or from 10:1 to 3:1 (measured as a wet slurry prior to being wet laid, for example). This weight ratio can be from about 40:1 to 1:1, or 30:1 to 1:1, or from 20:1 to 1:1, or from 10:1 to 1:1, or from 5:1 to 1:1, or from about 10:1 to 4:1 or from 10:1 to 5:1 or from 10:1 to 6:1 or from 9:1 to 3:1 or from 8:1 to 3:1, or from 7:1 to 3:1, or from 6:1 to 3:1 or any range based upon any two values described herein.

The single layer or the first layer can further comprise or include at least one flocculant. The flocculant can be generally evenly present throughout the layer. The aerogel to flocculant weight ratio can be from 20:1 to 1:1, or from 10:1 to 1:1 or from 5:1 to 1:1 or from 3:1 to 2:1 (measured as a wet slurry prior to being wet laid, for example). This weight ratio can be from 4:1 to 1:1, or from 3:1 to 1:1, or from 2:1 to 1:1, or from about 3:1 to 2.5:1 or from 3:1 to 2.75:1 or any range based upon any two values described herein.

The flocculant in the single layer or the first layer can be present in an amount of from 1 wt % to 10 wt % (dry mass) based on the total dry weight of the first layer. This amount can be from 1.5 wt % to 10 wt %, from 2 wt % to 10 wt %, from 3 wt % to 10 wt %, from 4 wt % to 10 wt %, from 5 wt % to 10 wt %, from 6 wt % to 10 wt %, from 7 wt % to 10 wt % or any range based upon any two values described herein. A layer of a multi-layer, or the single layer, or all layers can optionally not have any flocculant present.

The flocculant can be an organic flocculant. The flocculant can be an inorganic flocculant. The flocculant can be a polymeric organic flocculant. The flocculant can be an inorganic salt of a multivalent metal (e.g., aluminum, iron, calcium, magnesium, or zinc).

The flocculant can be a polymeric flocculant such as a polymeric organic flocculant. Examples include polyelectrolytes (cationic or anionic), non-ionic polymers, polysaccharides (e.g., starch, chitosan such as cationic types), polypeptides, polyamines, or polyacrylamides. Other examples of the flocculant include, but are not limited to, aluminum sulfate (alum), aluminum chloride, sodium aluminate, aluminum chlorohydrate, polyaluminum chloride, ferric chloride, ferric sulfate, ferrous sulfate, ferric chloride sulfate, or calcium salt versions thereof, or magnesium salt versions thereof, or zinc salt versions thereof.

The single layer or the first layer can further comprise or include at least one viscosity modifier. The viscosity modifier in the single layer or the first layer can be present in an amount of from 1 wt % to 10 wt % (dry mass) based on the total dry weight of the first layer. This amount can be from 1.5 wt % to 10 wt %, from 2 wt % to 10 wt %, from 3 wt % to 10 wt %, from 4 wt % to 10 wt %, from 5 wt % to 10 wt %, from 6 wt % to 10 wt %, from 7 wt % to 10 wt % or any range based upon any two values described herein. A layer of a multi-layer or the single layer, or all layers can optionally not have any viscosity modifier present.

The viscosity modifier can be generally evenly present throughout the layer. The aerogel to viscosity modifier weight ratio can be from 90:1 to 1.5:1 or from 80:1 to 1.5:1, or from 70:1 to 1.5:1, or from 60:1 to 1.5:1, or from 50:1 to 1.5:1, or from 40:1 to 1.5:1, or from 30:1 to 1.5:1, or from 20:1 to 1.5:1, or from 10:1 to 1.5:1, or from 5:1 to 1.5:1 (measured as a wet slurry prior to being wet laid, for example). This weight ratio can be from about 5:1 to 2:1, from 5:1 to 2.5:1, from 5:1 to 3:1, from 4:1 to 1.5:1, from 3.5:1 to 1.5:1 or any range based upon any two values described herein.

The single layer or the first layer of the insulating member can be such that aerogel (e.g., aerogel particles) can be present by weight in the single layer or first layer in an amount of from 10 wt % to 90 wt % based on the total dry weight of the first layer. This amount can be from 20 wt % to 80 wt %, from 30 wt % to 70 wt %, from 40 wt % to 70 wt %, from 50 wt % to 90 wt %, from 60 wt % to 90 wt %, from 10 wt % to 30 wt %, from 10 wt % to 40 wt % or any range based upon any two values described herein.

The single layer or the first layer of the insulating member can be such that the first fibrous component (e.g., glass fibers) can be present by weight in the single layer or the first layer in an amount of from 10 wt % to 90 wt % based on the total dry weight of the first layer. This amount can be from 20 wt % to 80 wt %, from 30 wt % to 70 wt %, from 40 wt % to 70 wt %, from 50 wt % to 90 wt %, from 60 wt % to 90 wt %, from 10 wt % to 30 wt %, from 10 wt % to 40 wt % or any range based upon any two values described herein.

The first layer can be a non-woven layer. The first layer, in at least one embodiment, can be considered a wet laid non-woven layer.

Additional components can be present in the single layer or the first layer. The single layer or the first layer can further comprise or include at least one polymer, at least one metal oxide, and/or at least one inorganic particle that is other than a metal oxide. The first layer or the slurry utilized to make the first layer can further include materials such as IR opacifiers, and/or flame or fire retardants, and/or heat absorbers, and/or processing aids, and so forth. Other examples include one or more binders, water, dispersants, emulsifiers, and/or flocculating agents, etc. that can be included as needed in the manufacture of the single layer and/or the first layer and/or the second layer.

The single layer or the first layer can further comprise or include at least one IR opacifier. Examples of an IR opacifier include, but are not limited to, carbon black, alumina, graphite, titanium dioxide, iron oxide, silicon carbide, or zirconium dioxide, or any combination thereof.

With regards to the aerogel component of the single layer or the first layer, further details are provided.

In specific implementations, the aerogel is a silica aerogel in particulate form. Any type of silica aerogel particle(s) can be used. Aerogels may be formed as described in U.S. Pat. No. 7,470,725. Suitable aerogels can be made from waterglass or from organic materials such as TEOS and TMOS. To reduce the radiative contribution to thermal conductivity, the aerogel particles can incorporate IR opacifiers, such as carbon black, alumina, graphite, titanium dioxide, iron oxide, silicon carbide, zirconium dioxide, or mixtures thereof. Aerogel particles are available from a variety of sources, including from Cabot Corporation under the ENOVA or ENTERA brands and from JIOS Aerogel under the AEROVA brand.

The aerogel can be surface modified as an option. Various surface modifiers are described in U.S. Patent Application Publication No. US2001034375, incorporated in its entirety by reference here.

The silica aerogel can have particle sizes in a range from 0.1 mm to 5 mm, for example, from 0.1 mm to 4 mm, from 0.1 mm to 1.5 mm, or from 1 mm to 4 mm. The aerogels can have narrow or wide particle size distributions and can be in the form of comminuted powders. The diameter of an aerogel particle is measured along the longest cross-sectional line in a given particle.

The silica aerogel particles can be hydrophobic, exhibiting a water contact angle of greater than 90 degrees. Examples of commercially available aerogels are ENOVA brand aerogels, from Cabot Corporation, and P100 and P200 aerogels also from Cabot Corporation.

The aerogel can be a mixture of silica aerogel and hydrophobic silica aerogel.

Aerogel particles are also commercially available as mixtures with opacifiers such as carbon black.

As the aerogel is preferably pre-formed (prepared prior to the fabrication of the first layer herein), any desirable aerogel structure, morphology, or other characteristic can be chosen, and this characteristic can often exist in the final product.

With regards to the first fibrous component, further details are provided. The fibrous component can include ceramic wool and/or a polymeric fiber that is temperature resistant. Examples of such polymeric fibers are polybenzimidazole (PBI), an aromatic polyamide (aramid) or any combination thereof. These materials can be provided in an amount of 0.5 to 100 wt % based on the total weight of the entire fibrous component in the first layer. In one example, wools and/or heat resistant polymeric fibers are provided in a relative amount that is less than 50 weight %, e.g., less than 40, less than 30, less than 20 or even less than 10 weight %, based on the weight of the entire fibrous component of the first layer.

Whereas ceramic fibers are typically made by a drawing process, then chopped to a desired length, a ceramic “wool” (or other types of wool, such as mineral wool, also sometimes referred to as “stone” wool) is often made by spinning a melt. Generally, wools tend to have longer, more entangle-prone fibers. Individually, a wool fiber may not be any stronger than a shorter ceramic fiber (made by drawing and chopping). In bulk, however, wools may have an additive effect that can improve the mechanical integrity of the heat control article.

The diameter of a wool fiber can be within a range of from about 1 micron (μm) to several hundreds of microns. Fiber length can be within a range of from about 100 μm to several hundreds of μm or longer, sometimes several hundreds of millimeters (mm) long.

These high aspect ratio wools also have the effect of improving drainage and retention in a wet laid article, as they provide extra surface area for well-dispersed active materials to aggregate during coagulation processes. This reduces the amount of active material that is removed with the excess process water during forming processes.

Amounts of ceramic wool that can be employed often will depend on desired properties (e.g., tensile strength, tear resistance, impact resistance), intended use and/or other factors. Ceramic wools can be provided in an amount within a range of 0.5 to 100 wt % (relative to the weight of the fibrous component utilized to prepare the composition of the first layer). As an option, the ceramic wool can be present in an amount within a range of from about 5 to about 30 wt %. For instance, it can be present in the fibrous component in an amount of from about 10 to about 20 wt % based on the total weight of the fibrous component in the first layer.

Relative to the finished article, e.g., a blanket, ceramic wools can be present in the end product in an amount within a range of 0.25% to 4% of the weight of the first layer, e.g., from about 0.5 to about 2 wt %, such as, for instance, within a range of from about 0.5 to about 1.0; from about 0.5 to about 1.5; from about 0.5 to about 2.0 wt %; or within a range of from about 1.0 to about 1.5; from about 1.0 to about 2 wt %; or from about 1.5 to about 2.0 wt %.

Suitable ceramic wools include aluminum (provided as Al₂O₃), silicon (in the form of SiO₂) and iron (in Fe₂O₃) or combinations of any of these. Some ceramic wools can also include titania (TiO₂) in addition to or in place of any of these components.

While not a required element, the presence of zirconium can bring about mechanical benefits and/or can contribute to the temperature resistance of the final heat control article (e.g., a blanket). In some implementations, zirconium (typically in the form of zirconium oxide (ZrO₂) is provided in a zirconium containing wool that can also include other elements such as aluminum, silicon, iron and/or titanium. Commercially, Ceramaterials (Dingmans Ferry, PA) provides two types of spun fibers, one with a higher zirconia concentration (with temperature resistance up to 2600° F./1400° C.) and one with lower zirconia loading (2300° F./1400° C.).

Another type of wool that can be employed to prepare the composition described herein is mineral wool (also known in some instances as “stone” wool). Mineral wool is commercially available from Rockwool A/S under the trade name of “Rockwool®” mineral wool, from Knauf Insulation (Shelbyville, IN, USA), and from other suppliers. Amounts of mineral wool can be the same or similar to those used in the case of ceramic wools. Other ranges can be employed, however.

In some embodiments, the composition described herein to form the first layer can contain temperature resistant polymeric materials in various forms. Some approaches utilize aramid fibers that can be defined as “pulp” (between 0.1-6 mm) or short cut fibers (>6 mm). Aramid short cut fibers and pulp are widely available, with the major worldwide manufacturer being Dupont (under the Kevlar® tradename).

Other approaches utilize polybenzimidazole (PBI) fibers, typically characterized by excellent heat and chemical resistance. As PBI fibers have no discernible melting point, they do not ignite or drip when exposed to high temperatures. PBI fibers can be purchased from PBI Performance Products (Charlotte, NC).

Materials such as aramid or PBI fibers are believed to be particularly useful in addressing the swelling and contraction observed with battery packages charging or discharging under hot or cold conditions. Allowing the battery encasement to expand alleviates pressure on the battery compartment, reducing wear and tear on battery materials.

While still imparting these advantageous properties, these polymeric fibers are typically used in amounts that are as low as possible, as their addition can compromise a desired low flammability rating of the finished article, e.g., blanket.

PBI and/or aramid fibers can be provided in amounts within a range of from about 0.5 to 100 wt % (relative to the weight of the fibrous component utilized to prepare the composition that forms the first layer). In illustrative examples, they are present in an amount within a range of from about 5 to about 30 wt %. For instance, they can be present in the fibrous component in an amount of from about 10 to about 20 wt %.

The fibers such as aramid or PBI can be used in amounts of 0.25% to 4% (based on the weight of the article), e.g., from about 0.5 to about 2 wt %, such as, for instance, within a range of from about 0.5 to about 1.0 wt %; from about 0.5 to about 1.5 wt %; from about 0.5 to about 2.0 wt %; or within a range of from about 1.0 to about 1.5 wt %; from about 1.0 to about 2 wt %; or from about 1.5 to about 2.0 wt %.

Suitable chopped ceramic fibers that can be employed in the composition described herein include one or several (two, three, four or more) inorganic oxides, such as Al₂O₃, B₂O₃, Na₂O, K₂O, CaO, and MgO. Some fibers may also include silicon oxides. Many types of ceramic fibers, often well characterized with respect to composition, length and/or other properties, are available commercially. Suitable chopped ceramic fibers include but are not limited to 7000 and 6000 series fibers from Unifrax. In one example, the ceramic fibers are a high purity alumina-silica product coarsely chopped from Unifrax.

Glass or other fibers may be used, typically in combination with the ceramic fibers and/or the ceramic wools, aramid and/or PBI fibers described above. Illustrative glass fibers include: borosilicate (B Fiber) and calcium aluminoborosilicate (E Fiber), which can be obtained, for example, from Lauscha Fiber International; and/or fibers that consist essentially of silica (Q fibers), which can be obtained, for example, from Johns Manville.

Other fibers that can be added to the ceramic fibers, ceramic wools and/or the polymeric fibers such as PBI or aramid include non-ceramic fibers such as cellulose, cotton, carbon, acrylic, polyvinyl alcohol (PVA), phenolic, polyolefin and/or other types of fibers, as well as mixtures of such fibers.

The fibers employed may be in any configuration known to those of skill in the art. For instance, the fibers may be in the form of chopped fiber, microfibers, woven fibers, or non-woven fibers.

The shape of the fiber cross section can be round, polygonal, trilobal, pentalobal, octalobal, in the form of strips, fir trees, dumb bells, or other shape. Fibers may have consistent or varying diameters along the length of the fiber. Hollow fibers can be used in some embodiments. Additionally, the fiber materials can be smooth or crimped and may be curled or straight.

Coated fibers can be employed in some embodiments. Polyester fibers metallized with a metal such as aluminum are one example.

Also suitable are fibers modified by additives. Examples of such additives include but are not limited to: anti-static agents such as carbon black, for instance; and/or IR opacifiers (typically used to reduce the radiation contribution to thermal conductivity) such as carbon black, titanium dioxide, alumina, iron oxide, or zirconium dioxide, silicon carbide, or any mixtures thereof. Each additive or total additive amounts can be used in amounts from 0 wt % to 20 wt % on a dry weight basis based on a layer or the overall insulating member. These amounts can be at least 1 wt %, at least 2 wt %, at least 5 wt %, at least 10 wt %, at least 15 wt %, such as from 0.1 wt % to 20 wt %, or from 0.5 wt % to 20 wt %, or from 1 wt % to 20 wt % (based on a dry weight basis of a layer or overall insulating member).

In addition to including IR opacifiers, the radiation contribution to the thermal conductivity can be further reduced by using blackened fibers, such as polyester fibers blackened with carbon black or simply carbon fibers.

The amount of fiber used depends on its density, diameter, length, etc. and can be from 1% to 99% with respect to the weight of the first layer. In specific embodiments, the weight ratio of the aerogel component to the first fibrous component can be within a range of from 1:10 to 10:1, e.g., 1:1 to 1:2.

The length and diameter of the fibers, often ceramic fibers, can vary with the specific application. Thinner fibers, for example, can add flexibility, while the length and/or distribution of the fibers can play a role in increasing the mechanical strength of the final product, a blanket, for example. Two or more different types of fibers or fibers made of the same material but characterized by different fiber lengths can be used to obtain a bimodal or multimodal length distribution of fibers.

In addition to the aerogel component, the composition described herein preferably further includes one or more other ingredients. In many cases, these ingredients or components are selected to bring about specific functions and/or properties to the final articles (e.g., a blanket). In some cases, the types and/or amounts of added ingredients are selected to achieve a balance or compromise between desirable versus less desirable contributions the ingredient might make to the final product. Manufacturing parameters, final applications or other factors can be considered in selecting types and/or amounts of ingredients to be employed.

In some embodiments, the composition includes silicone particles. This material is believed to potentially improve both the reinforcement and elasticity of the finished article, e.g., a blanket.

Silicone powders or particles of various average particle size (avg PS), e.g., within a range of from about 1 micron to 1 mm in diameter, are commercially available. As one example, a supplier such as Shin Etsu Silicones, provides suitable elastic particles under their Silicone Powder KMP series. For instance, particles with an avg PS of 13 μm are available under product code KMP-598, while product KMP-402 provides a PS=30 μm.

Suitable amounts that can be employed can be determined taking into account desired properties, manufacturing parameters and/or other factors. In some implementations, silicone particles are provided in a ratio (e.g., weight ratio) of up to 1:1 relative to the aerogel component.

Silicone rubber particles can be employed in conjunction the ceramic fibers and/or the wools and/or the temperature resistant polymeric fibers described herein. For example, they can be combined with the aerogel particles, with the ceramic fibers and/or with the ceramic wool, aramid fibers and/or PBI fibers. Alternatively, silicone particles can be used in compositions that do not include a ceramic wool or a polymeric fiber such as aramid or PBI.

In many embodiments, the composition described herein includes opacifiers, such as infrared (IR) opacifiers, to reduce radiative heat transfer. These materials reduce the transmission of infrared radiation and can include, for instance, carbon black, mica, alumina, graphite, titanium dioxide, rutile sand, iron oxide, silicon carbide (SiC), graphite or zirconium dioxide. Some suitable types of titanium dioxide include, for example, Tipure® (DuPont) and Altiris® (Huntsman). IR opacifiers may be used individually or as mixtures of two or more compounds.

IR opacifiers can be added in amounts selected to provide a target level of IR transmission reduction in the heat control article (e.g., blanket). Illustrative such levels may be, for example, from 2% to 150%, 2% to 100% or 5% to 40% opacifier based on the weight of the mixture of silica aerogel and hydrophobic silica-containing particles. Adding opacifiers characterized by two or more different average particle sizes in a given composition may extend the range of IR wavelengths being covered.

In some embodiments, the heat control article (blanket) can include a flame or fire retardant. Flame retardants may be, for example, alkali oxides, alkali earth metal oxides, aluminum trihydrate, magnesium hydroxide, antimony oxides, titanium dioxide, rutile sand, melamine compounds, phosphate based or halogen based compounds. In specific embodiments, titanium dioxide particles may have a diameter of about 1.18 μm, from 0.9 to 1.3 μm, from 0.8 to 1.4 μm or from 0.5 to 4.0 μm, and in certain embodiments the particle size distribution may have a d50 of about 1.0 μm+/−0.01 μm, +/−0.02 μm or +/−0.05 μm. Halogenated flame retardants include, for example, brominated flame retardants (BFR) such as organobromide compounds including polymeric organobromide compounds. In another set of embodiments, the flame retardant has a structure with a high ratio of heteroatoms to carbon atoms. For example, in some embodiments the ratio of heteroatoms to carbon atoms may be greater than 0.5 to 1, greater than 1 to 1, or greater than 2 to 1, and in specific embodiments the heteroatoms may be nitrogen and/or sulfur. Flame and/or fire retardants can be incorporated into the heat control member in concentrations adequate to suppress flammability or to meet specifications such as UL94-V0. Alternatively or in addition, embodiments of heat control members may exhibit caloric content of, for example, less than 10 MJ/kg, less than 8 MJ/kg, less than 5 MJ/kg, less than 3 MJ/kg, less than 2 MJ/kg, or less than 1 MJ/kg, for example, from 0.5 MJ/kg or 1 MJ/kg to 5 MJ/kg.

Concentrations (for instance in the first layer and/or both layers) of fire and/or flame retardant that can be employed may range, by weight, from 0.1% to 5.0%, 0.2% to 2.0%, and 0.3% to 1.5% with respect to the mass of the heat control member. In specific implementations, the flame or fire retardant is combined with the aerogel particles, e.g., with a mixture combining silica aerogel and hydrophobic-silica containing particles.

Heat absorbing materials also can be employed. Such materials help the heat control article (e.g., blanket) behave not only as an insulator, retarding heat transfer, but as a heat capacitor which can store thermal energy. Such heat absorbing materials may include aluminum hydroxide and others known to those of skill in the art. Alternatively or in addition, heat absorbing materials may include phase change materials that store heat by undergoing a thermodynamic phase transformation. Heat absorbing materials can be combined with aerogel particles and/or hydrophobic silica aerogel or can be deposited on the surface of or otherwise impregnated into the aerogel pores.

The composition for forming the first layer can include a binder. In some situations, the binder can help prevent widespread dispersion or dissipation of the silica aerogel, hydrophobic silica-containing particles, and/or other particulate components of the insulating member, in case of a catastrophic failure or explosion of the item being insulated, e.g., a battery. Examples of suitable binders include but are not limited to silicone, polyvinyl alcohol, polyvinylidene fluoride, polyethylene terephthalate, polybutylene terephthalate, acrylate polymers, and so forth. Binders that include heat resistant and/or flame retardant polymers are preferred. A binder such as polyvinyl alcohol can also bind additives such as carbon black to aerogel particles to alleviate dusting during assembly. Binders may be mixed with a portion or all the components of the mixture, including any additives incorporated into the mixture, using an impeller or other suitable apparatus known to those of skill in the art. Preferably, the binder does not render the aerogel blanket flammable under UL94 or other flammability test methods.

Processing aids also can be included in the composition that forms the first layer. The processing aid(s) chosen will depend on the manufacturing method and form of the heat control article. Suitable processing aids include but are not limited to defoamers, surfactants, dispersants, and emulsifiers.

While in many cases ingredients can be combined in any suitable manner, techniques for incorporating some of the components can benefit from additional consideration. With fibers, for example, too little mixing energy can lead to undispersed bundles of fibers that do not efficiently improve performance. Overdispersion (under unrestrained length of mixing or mixing energy), on the other hand, can lead to self-entanglement and “balling”. Too much chopping and cutting energy can result in reducing the length of the fiber to a less than ideal length, affecting product attributes or performance. As for equipment, it was found that mixing operations that rely on a cutting blade with a sharp leading edge can also contribute to fiber length reductions. While on a short time scale this could be relatively benign, the effect is expected to accelerate over longer periods.

It was also found that certain properties of the material being incorporated can render the material more susceptible to “overprocessing” effects. In the case of fibers, for example, such effects become more significant for fiber lengths greater than about 6 mm (0.25 inch) and/or fine coarseness.

Thus, some embodiments described herein relate to controlling some of the mixing parameters such as time of mixing, energy supplied, type of equipment, e.g., blade type. In specific examples, mixing parameters take into account properties of the material being processed. In others, properties of the material are evaluated, then correlated to suitable mixing parameters. Establishing suitable mixing parameters can be based on routine experimentation, prior experience, and so forth.

To form the first layer (or to form the slurry that is dispersed in the mat for the single layer) described herein, ingredients can be combined in any suitable manner and can involve a single step. In many cases, however, mixing is performed in a sequence of two or more steps, using equipment known in the art. In one example, aerogel particles and fibers are added to a solution containing processing aids such as defoamers, surfactants, dispersants, and/or emulsifiers.

The first layer may take any form known to those of skill in the art. For example, the techniques as described in, e.g., U.S. Pat. No. 9,399,864, US20210363699, WO2022024085, CN112759353, U.S. Pat. No. 11,274,044, CN112681009, CN113943171, CN110093783, CN112681009, JP2015048543, and/or US20200295328, the contents of all of which are incorporated herein by reference, can be utilized in making the first layer taking into account the details of the first layer as provided herein. This can be applicable to formation of the single layer as well.

As indicated, the first layer can be formed in a wet laid process. And, the dispersing of the aerogel and first fibrous component into the mat to form the single layer can be formed in a wet laid type process. Generally, in a “wet laid” process, aerogel particles and optional materials are flocculated from an aqueous slurry to form a substantially stable homogeneous suspension of particles (floc). The floc can separate from the aqueous based solvent, forming a two-phase system consisting of flocculated aerogel particles and a supernatant of substantially water. The flocculated material can support an even distribution of the different particles from which the first layer can be made. This stable, consistent distribution of particles can provide a first layer that exhibits a uniform composition throughout.

In one embodiment, such as described in U.S. Pat. No. 9,399,864, an aqueous slurry is prepared with the mixture of silica aerogel, hydrophobic silica-containing particles, ceramic fibers, and other components (e.g., binders, opacifiers, fire retardants, defoamers, etc.). A charged compound or other emulsifier or dispersant is added to the slurry to create an emulsion, which is then coagulated with a flocculating agent. This process can be adopted here taking into account the aspects of the present invention as described herein.

The resulting floc can then be poured or otherwise put on the second layer, wherein the second layer can be on a belt. The first and second layers can be then be dewatered.

As an option, the act of flocculating the composition (e.g., slurry) that forms the first layer can be controlled so that the floc is smaller floc. A smaller floc can drain more slowly when wet laid on the second layer and entangle with the fibrous second layer. This can lead to better overall properties in the final product, such as flammability and/or adhesion properties. As an option, the flocculating is under flocculated, meaning, the flocculation does not reach completion in the slurry (e.g., the under flocculation can be less than 99% completion, less than 95% completion, less than 90% completion, less than 85% completion, less than 80% completion, such as from 75% to 95% completion, where the % is the degree of flocculation with 100% being fully flocculated). This can be achieved by using less flocculant.

Without being bound by any particular theory, it is believed that as the flocculation becomes more efficient, the aerogel particles are able to pack more densely in the first layer. In preferred embodiments, the aerogel particles constitute at least 40% by mass of the first layer, for example, at least 42%, at least 44%, at least 46%, at least 48%, or at least 50%, for example, from 40% to 55%, from 40% to 60%, or from 40% to 65% by mass.

Flocculation agents preferably are able to flocculate sufficient solids in the mixture such that the bulk of the solids float to the top of the aqueous mixture, leaving the aqueous media relatively clear, rather than cloudy. Exemplary flocculation agents include but are not limited to polydiallyldimethylammonium chloride (PDADMAC) and SuperFloc® 577 (Kemira).

In certain embodiments, the packing density of the various components may be increased by using compression to pressing additional water out of the floc prior to drying. For example, the floc may be passed through a roll press. The roll press increases the packing density of the various components by squeezing water from the floc. In the final product, this reduces interparticle porosity as the remaining water is replaced by air during drying.

The flexible insulating member (a blanket, for instance) may be fabricated in roughly planar or flat form for insertion between cells of a rechargeable battery, e.g., a lithium ion battery. In other approaches, the insulating member can be prepared in another desired shape. For example, the insulating member may be shaped to be disposed about a particular component in a battery or other device and may have a more complicated shape.

In some embodiments, the insulating member includes an additional sheet-like material to enhance mechanical integrity, heat resistance, mechanical resilience, and/or other properties. Examples include but are not limited to silicone-based materials, polyvinylidene fluoride, chlorinated polyethylene, aramid materials such as Kevlar (e.g., woven mats of aramid fibers), and Kevlar nanofiber aerogels such as those described in Lyu, et al., ACS Nano 2019, 13, 2236-2245. Woven mats of Kevlar or other aramid fibers may be impregnated with a shear thickening fluid such as those described in U.S. Pat. No. 7,825,045, the contents of which are incorporated herein by reference.

An envelope can be used in some cases, serving to prevent dusting, help maintain the shape of the insulating member, facilitate its manipulation or installation, and so forth. The material that forms the envelope is preferably a flame retardant and/or heat resistant polymeric material, including, for instance, silicones, polyvinylidene fluoride (PVDF), chlorinated polyethylene, and other similar polymers known to those of skill in the art. Alternatively, or in addition, the material for the envelope may include a reinforcing fiber such as an aramid fiber to provide puncture resistance. A reinforcing material may be used in combination with other polymers or the envelope may be formed entirely of such polymers, e.g., a woven cloth of aramid fiber.

The first layer (or the single layer), that can be a non-woven blanket, e.g., by a wet laid process, is believed to bring about significant benefits to the finished product. Thus, the insulating member described herein can have excellent insulating properties, e.g., to reduce heat propagation from a battery cell experiencing thermal runaway to neighboring cells or other battery components. The composition is preferably non-flammable, producing an article that will pass the UL94-V0 test or other flammability/combustibility tests.

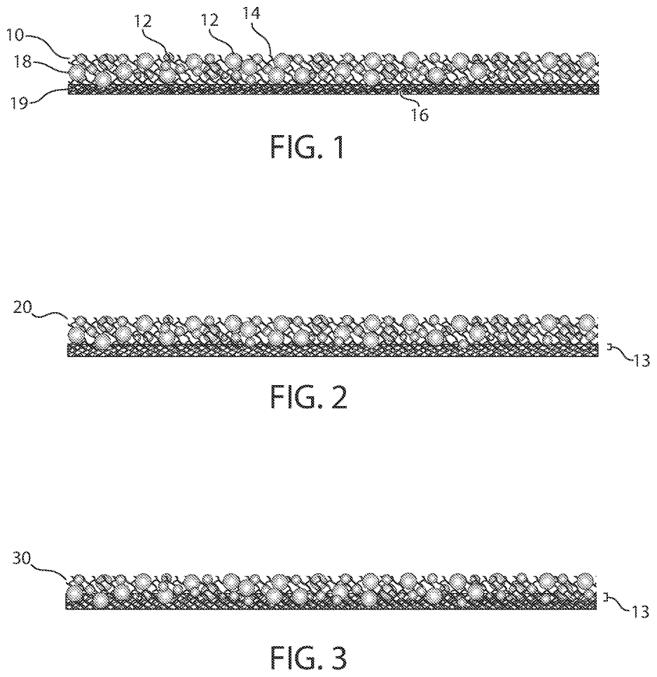

The figures, namely FIGS. 1 to 5 show various embodiments of the present invention. Specifically, FIG. 1 is a blown-up side view of one example of the flexible insulating member 10 of the present invention, which is multi-layer and where there is slight intermeshing or intermixing of the first layer with the second layer. As shown in FIG. 1, first layer 18 is located above second layer 19 and the two layers are affixed together. The bottom of the first layer 18 slightly intermeshes or intermixes with the top of layer 19. Aerogel particles 12 (optionally of various sizes) and a first fibrous component 14 at least in part form the first layer 18. Second layer 19 is formed of a second fibrous component 16.

FIG. 2 is a blown-up side view of another example of the flexible insulating member 20 of the present invention, which is multi-layer and where there is more intermeshing or intermixing of the first layer (approx. 10% to 50% of the thickness of the second layer) with the second layer to define a region 13 of intermeshing or penetration. FIG. 2 otherwise shows the same components as FIG. 1.

FIG. 3 is a blown-up side view of another example of the flexible insulating member 30 of the present invention, which is multi-layer and where there is even more intermeshing or intermixing of the first layer (approx. 50% to 90% of the thickness of the second layer) with the second layer to define a region 13 of intermeshing or penetration. FIG. 3 otherwise shows the same components as FIG. 1.

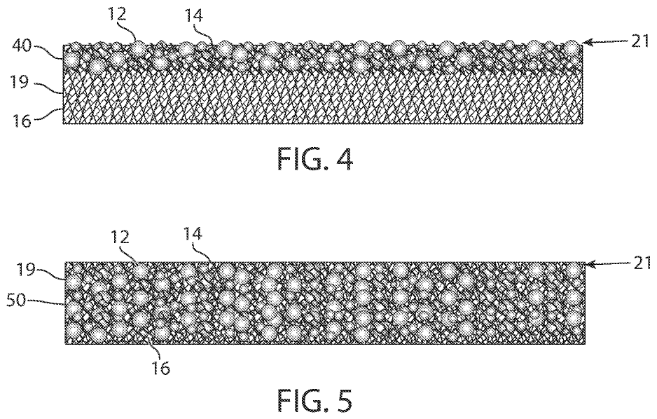

FIG. 4 is a blown-up side view of a further example of the flexible insulating member 40 of the present invention, which is single layer 19 and where the aerogel 12 and first fibrous component 14 are fully intermeshed or embedded or penetrated into the upper portion of the mat 16. As shown in FIG. 4 (arrow 21), the aerogel 12 and first fibrous component are slightly exposed in part on the top outer surface of the single layer 19.

FIG. 5 is a blown-up side view of a further example of the flexible insulating member 50 of the present invention, which is single layer 19 and where the aerogel 19 and first fibrous component 14 are fully intermeshed or embedded or penetrated into the entire thickness of the mat 16. The more easily seen mat 16 (in FIG. 4) is, in this FIG. 5 fully intermeshed or embedded with the aerogel 12 and first fibrous component 14. As shown in FIG. 5 also (arrow 21), the aerogel 12 and first fibrous component 14 are not exposed on the top outer surface of the single layer 19.

Additional benefits imparted to the insulating member may include increased flexibility, compressibility, elasticity, tensile strength, and/or impact resistance. Allowing the battery encasement to expand and contract, these articles contribute to mitigating the effects of dimension changes of the battery compartment (e.g., cells, modules and packs), reducing the wear-and-tear this type of cycling can have on the battery materials.

The insulating member can exhibit excellent thermal stability. For example, the insulating member may shrink less than 2% after aging at 650° C. according to ASTM-C356. The insulating member may have a thermal conductivity at 25° C. of less than 40 mW/m K or less than 30 mW/m K, preferably less than 25 mW/m·K, more preferably less than 20 mW/m·K, for example, from 5 mW/m K to 20 mW/m·K or from 8 mW/m·K to 15 mW/m K or from 15 mW/m·K to 25 mW/m K (or any range based upon any two values described herein) according to test method ASTM C518.

The insulating member can be flexible, a property that may be measured according to ASTM C1101 or another suitable technique. Manual bending tests can be useful, especially at the initial screening stages of a product.

In specific implementations the insulating member is a blanket having a flammability rating of non-flammable according to UL94-V0.

The flexible insulating member (either single layer or multi-layer) provided herein may further be part of a composite insulating structure. In one embodiment, the composite insulating structure comprises a sandwich of two, three, or more flexible insulating members as provided herein, where at least one of the flexible insulating members includes a higher concentration of IR opacifier, e.g., carbon black. The concentration of carbon black may be from 0.5 to 10 wt %, for example, from 1 wt % to 8 wt % or from 3 wt % to 6 wt %. Carbon black is one of the most effective IR opacifiers but is highly flammable. By protecting a flexible insulating member having a higher concentration of carbon black with a flexible insulating member having a lower concentration (less than 0.5 wt %, for example, less than 0.4 or 0.3 wt %) or no carbon black, the carbon black can provide IR absorption at high temperatures (closer to 1000° C. and above) where IR conduction is an important vector for heat transfer while the carbon black-poor, e.g., carbon black-free, flexible insulating member acts as a thermal buffer protecting the carbon black rich flexible insulating layer from oxidation. Alternatively, a carbon black-rich flexible insulating member may be sandwiched between two carbon black-poor flexible insulating members to form a three-part composite.

Alternatively or in addition, the flexible insulating member may be fabricated as a carbon black-rich or carbon black-poor material and used in combination with aerogel blankets or papers that are fabricated from aerogel and fiber by other methods and with less or more carbon black, respectively. For example, a carbon black-rich flexible insulating member may be sandwiched with one or more carbon black-poor aerogel blankets and papers produced according to other methods known to those of skill in the art, for example, as described in U.S. Pat. Nos. 11,380,953, 9,868,843, WO2022024085, U.S. Pat. No. 11,274,044, WO2021045484, WO2021219976, WO2022189425, US2022200080, WO2024059682, WO2023230251, U.S. Pat. Nos. 7,635,411, and 9,399,864, the entire contents of all of which are incorporated herein by reference. Such aerogel blankets or pads may comprise 10 wt % to 90 wt % aerogel, for example, from 20 wt % to 80% or from 30 wt % to 70 wt % or from 40 wt % to 50 wt % aerogel. Such aerogel blankets or pads may comprise 10 wt % to 90 wt % fiber, for example, from 20 wt % to 80% or from 30 wt % to 70 wt % or from 40 wt % to 50 wt %. The fiber may be any of the fibers described above or may be fiberglass or another woven or non-woven fiber mat. Alternatively or in addition, one or more carbon black-poor flexible insulating members may be used to sandwich carbon black-rich aerogel blankets and papers produced according to other methods known to those of skill in the art, including any of the patent references listed above.

Composite insulating structures may be produced by laminating two or three flexible insulating members or other aerogel blankets or papers together with adhesive or by exploiting any cohesive tendencies of such materials. Alternatively or in addition, a second layer maybe applied as a coating on the flexible insulating member by spray coating, using an emulsion, or using other coating techniques known to those of skill in the art. In this embodiment, formulations similar to those used to produce the flexible insulating member (except with more or less carbon black, as appropriate) may be employed. Alternatively or in addition, an additional emulsion may be flocculated onto the flexible insulating member, essentially substituting the flexible insulating member for the mat in the methods provided herein. Where the composite insulating structure is a three-part structure, each of the three portions may be formulated and/or adhered differently to form the full composite insulating structure.

The carbon black can be any carbon black known to those of skill in the art. Preferably, the carbon black is one having a low surface area, for example, an iodine number of 15 to 60 g/kg. Exemplary carbon blacks include Regal 85, Spheron 6000, and Monarch 120 carbon blacks from Cabot Corporation. Alternatively or in addition, carbon blacks that have been surface treated to decrease the pH, e.g., Mogul E carbon black from Cabot Corporation, may be employed. Such carbon blacks may be more compatible with water based systems for preparing the flexible insulating layer provided herein or for other aerogel blankets and papers prepared using aqueous media. Alternatively, higher surface area carbon blacks may provide enhanced IR opacification. Such carbon blacks also develop viscosity at lower loadings and may require increased use of dispersant. Exemplary higher surface area carbon blacks include but are not limited to Monarch 570 and Mogul L carbon blacks from Cabot Corporation. Other suitable carbon blacks are marketed under the Regal®, Black Pearls®, Elftex®, Monarch®, Mogul®, Spheron®, Sterling®, and Vulcan® trademarks by Cabot Corporation. Other commercially available carbon blacks include but are not limited to carbon blacks sold under the Raven®, Statex®, Furnex®, and Neotex® trademarks available from Birla Carbon, and the Corax®, Durax®, Ecorax® and Purex® products available from Orion Engineered Carbons. Other carbonaceous IR opacifiers that may be used in addition or as an alternative to carbon black (but in the same range of proportions as described above), include but are not limited to activated carbon, carbon aerogel, carbon xerogel, carbon fibers, reclaimed carbon from pyrolysis of carbon black filled plastic or elastomers, and partially carbonized polymer fibers, such as partially carbonized polyacrylonitrile or polyamide fibers, or combinations of any of these.

Alternatively or in addition, the composite insulating structure comprises the flexible insulating member in combination with an additional sheet-like material to enhance mechanical integrity, heat resistance, mechanical resilience, and/or other properties. Examples include but are not limited to silicone-based materials, polyvinylidene fluoride, chlorinated polyethylene, aramid materials such as Kevlar (e.g., woven mats of aramid fibers), and Kevlar nanofiber aerogels such as those described in Lyu, et al., ACS Nano 2019, 13, 2236-2245. Woven mats of Kevlar or other aramid fibers may be impregnated with a shear thickening fluid such as those described in U.S. Pat. No. 7,825,045, the contents of which are incorporated herein by reference.

Alternatively or in addition, the composite insulating structure comprises the flexible insulating member in combination with an envelope that can prevent dusting, help maintain the shape of the flexible insulating member, facilitate its manipulation or installation, and so forth. The material that forms the envelope is preferably a flame retardant and/or heat resistant polymeric material, including, for instance, silicones, polyvinylidene fluoride (PVDF), polyethylene terephthalate (PET), chlorinated polyethylene, and other similar polymers known to those of skill in the art. Alternatively, or in addition, the material for the envelope may include a reinforcing fiber such as an aramid fiber to provide puncture resistance. A reinforcing material may be used in combination with other polymers or the envelope may be formed entirely of such polymers, e.g., a woven cloth of aramid fiber. In one embodiment, the envelope may comprise one or two sheets of polymer film, e.g., PET film, disposed about the two planar sides of the aerogel composition. In some embodiments, a frame, e.g., of silicone rubber, may be disposed about the edges of the flexible insulating member and envelope to seal the envelope and ease handling of the resulting composite insulating structure.

Alternatively or in addition, the composite insulating structure may include several layers of the flexible insulating member stacked on top of one another. Optionally, the layers may be separated by any of the materials that are described above in connection with the envelope. Alternatively or in addition, the layers may be separated by foam pads or mica sheets to further improve insulation performance. Alternatively or in addition, such layers may be used on the outside of the composite insulating structure. In some embodiments, it may be desirable to include a heat conducting material that is configured to transport heat in a controlled fashion, for example, to a heat sink. The various layers may be attached to one another by any appropriate adhesive known to those of skill in the art, needled, or encapsulated by an envelope to maintain the laminate structure.

Alternatively or in addition, the flexible insulating member may include a coating. For example, a polymer or prepolymer solution or emulsion may be sprayed, painted, cast, or otherwise coated on one or more outside surfaces of the flexible insulating member or composite insulating structure and cured. Suitable cured polymers include polyolefins, silicones, polyvinyl alcohol, starches, polytetrafluoroethylene, phenolics, melamines, phenol formaldehyde, acrylic polymers and other polymers known to those of skill in the art. Such a coating can provide functionality similar to the envelope discussed above but with less material. Alternatively or in addition, the flexible insulating member may be surface treated, for example, it may be hydrophobized. The flexible insulating member may be contacted with a hydrophobizing agent such as a silane compound, a silazane compound, or a disiloxane compound. Examples of silane compounds include alkylhalosilanes having the formula R′ₓSiX₄₋ₓ and alkoxysilanes having the formula R′ₓSi(OR″)₄₋ₓ wherein R′ is selected from the group consisting of C₁-C₁₀ branched and straight chain alkyl or alkenyl, C₃-C₁₀ cycloalkyl, and C₆-C₁₀ aryl, R″ is C₁-C₅ branched or straight chain alkyl, X is a halogen, preferably chlorine, and x is an integer of 1-3. The flexible insulating member may be immersed in the hydrophobizing agent directly or exposed to a vapor of the hydrophobizing agent. Alternatively, the flexible insulating member may be immersed in a mixture of the hydrophobizing agent and an appropriate solvent. The temperature and pH of the treatment media may be adjusted as known to those of skill in the art to manipulate the degree of treatment. Exemplary treatment agents include but are not limited to trimethylchlorosilane, dimethyldichlorosilane, hexamethyldisilazane, hexamethyldisiloxane, and other hydrophobizing agents known to those of skill in the art. Hydrophobizing agents are preferably water-soluble and/or have a boiling point less than 200° C., less than 150° C., or preferably less than 100° C.

The present invention includes the following aspects/embodiments/features in any order and/or in any combination:
1. The present invention involves a flexible insulating member comprising a layer that is a mat comprising a second fibrous component, and a pre-formed aerogel and a first fibrous component dispersed in the mat, and said flexible insulating member is non-flammable per UL94 V0 and has a thermal conductivity at 25° C. of less than 40 mW/m·K, and has a thickness of at least 0.3 mm.
2. The flexible insulating member of of any preceding or following embodiment/feature/aspect, wherein the mat has a thickness and a porosity throughout the thickness, and wherein the aerogel and first fibrous component fills/occupies at least 50% of the porosity throughout at least 90% of the thickness of the mat.
3. The flexible insulating member of any preceding or following embodiment/feature/aspect, wherein the mat has an air permeability itself, and the air permeability is reduced by at least 50% after the pre-formed aerogel and a first fibrous component dispersed therein.
4. The flexible insulating member of any preceding or following embodiment/feature/aspect, wherein the pre-formed aerogel and a first fibrous component completely disperse below a top surface of the mat.
5. Alternatively or in addition, the present invention involves a flexible insulating member comprising:
   a first layer comprising aerogel and a first fibrous component, and
   a second layer that is a mat comprising a second fibrous component,
   wherein the first layer and second layer are affixed together, and said flexible insulating member is non-flammable per UL94 V0 and has a thermal conductivity at 25° C. of less than 40 mW/m·K, and has a thickness of at least 0.3 mm.
6. The flexible insulating member of any preceding or following embodiment/feature/aspect, wherein the flexible insulating member is a blanket, pad, or sheet.
7. The flexible insulating member of any preceding or following embodiment/feature/aspect, wherein the first layer and second layer are affixed together to have a peeling force of at least 0.1 kgf/cm³.
8. The flexible insulating member of any preceding or following embodiment/feature/aspect, wherein the flexible insulating member has a tensile strength of at least 10 N.
9 The flexible insulating member of any preceding or following embodiment/feature/aspect, wherein the flexible insulating member has a tensile strength of from about 10 N to 70 N.
10. The flexible insulating member of any preceding or following embodiment/feature/aspect, wherein the aerogel is aerogel particles.
11. The flexible insulating member of any preceding or following embodiment/feature/aspect, wherein the aerogel particles are hydrophobized aerogel particles.
12. The flexible insulating member of any preceding or following embodiment/feature/aspect, wherein the mat is a woven or non-woven mat.
13. The flexible insulating member of any preceding or following embodiment/feature/aspect, wherein the second layer has porous and/or has random openings or voids.
14. The flexible insulating member of any preceding or following embodiment/feature/aspect, wherein the first layer has an aerogel to first fibrous component weight ratio of from 10:1 to 1:10 as a wet slurry prior to being wet laid.
15. The flexible insulating member f any preceding or following embodiment/feature/aspect, wherein the first fibrous component comprises glass fiber, ceramic fiber, polymer fiber, carbon fiber, or any combination thereof.
16. The flexible insulating member of any preceding or following embodiment/feature/aspect, wherein the mat with the aerogel dispersed therein or the first layer further comprises at least one binder, and has an aerogel to binder weight ratio of from 50:1 to 1:1 as a wet slurry prior to being wet laid.
17. The flexible insulating member of any preceding or following embodiment/feature/aspect, wherein the mat with the aerogel dispersed therein or the first layer further comprises at least one flocculant, and has an aerogel to flocculant weight ratio of from 5:1 to 1:1 as a wet slurry prior to being wet laid.
18. The flexible insulating member of any preceding or following embodiment/feature/aspect, wherein the mat with the aerogel dispersed therein or the first layer further comprises at least one viscosity modifier, and has an aerogel to viscosity modifier weight ratio of from 5:1 to 1.5:1 as a wet slurry prior to being wet laid.
19. The flexible insulating member of any preceding or following embodiment/feature/aspect, wherein said first layer and said second layer are adhered together by portions of said first layer penetrating or entangling or embedding with portions of the second layer, and/or by chemical adhesion of portions of said first layer with portions of said second layer.
20. The flexible insulating member of any preceding or following embodiment/feature/aspect, wherein the thickness is from 0.3 mm to 20 mm.
21. The flexible insulating member of any preceding or following embodiment/feature/aspect wherein the second layer has at least a thickness in portions of the second layer that is from 0.1 mm to 10 mm.
22. The flexible insulating member of any preceding or following embodiment/feature/aspect, wherein said first layer and said second layer are adhered together in the absence of a separate adhesive layer.
23. The flexible insulating member of any preceding or following embodiment/feature/aspect, wherein in the mat with the aerogel dispersed therein or the first layer, said aerogel particles by weight are present from 10 wt % to 90 wt %, and said first fibrous component is present from 10 wt % to 90 wt %, based on the dry weight of the mat or the first layer.
24. The flexible insulating member of any preceding or following embodiment/feature/aspect, wherein said first layer is a non-woven layer.
25. The flexible insulating member of any preceding or following embodiment/feature/aspect, wherein said first layer is a wet laid non-woven layer.
26. The flexible insulating member of any preceding or following embodiment/feature/aspect, wherein the mat with the aerogel dispersed therein or the first layer further comprises at least one polymer, at least one metal oxide, at least one inorganic particle that is other than a metal oxide.
27. The flexible insulating member of any preceding or following embodiment/feature/aspect, wherein the flocculant is a polymeric organic flocculant or an inorganic salt of a multivalent metal.
28. The flexible insulating member of any preceding or following embodiment/feature/aspect, wherein the mat with the aerogel dispersed therein or the first layer further comprises at least one IR opacifier.
29. The flexible insulating member of any preceding or following embodiment/feature/aspect, wherein the at least one IR opacifier is carbon black, alumina, graphite, titanium dioxide, iron oxide, silicon carbide, or zirconium dioxide, or any combination thereof.
30. The flexible insulating member of any preceding or following embodiment/feature/aspect, wherein the aerogel particles have a particle size in a range of from 0.01 mm to 5 mm, for example, from 0.1 mm to 4 mm, from 0.1 mm to 1.5 mm, or from 1 mm to 4 mm.
31. The flexible insulating member of any preceding or following embodiment/feature/aspect, wherein the aerogel particles have porosities greater than about 60% and densities of less than about 0.4 g/cc, or densities of from about 0.05 to about 0.15 g/cc.
32. The flexible insulating member of any preceding or following embodiment/feature/aspect, wherein the aerogel has a thermal conductivity of less than about 40 mW/m·K, less than about 25 mW/m. K, or from about 12 mW/m·K to about 18 mW/m. K, or lower.
33. The flexible insulating member of any preceding or following embodiment/feature/aspect, wherein the aerogel has a caloric content of less than 10 MJ/kg, less than 8 MJ/kg, less than 7 MJ/kg or less than 6 MJ/kg.
34. The flexible insulating member of any preceding claim, wherein the first fibrous component comprises a ceramic wool and/or a polymeric fiber.
35. The flexible insulating member of any preceding claim, wherein the first fibrous component is present in an amount of from 10 wt % to 60 wt % based on the total dry weight of the mat or the first layer.
36. The flexible insulating member of any preceding or following embodiment/feature/aspect, wherein the flexible insulating member consists of said first layer and said second layer.
37. Alternatively or in addition, the invention involves a method of forming the flexible insulating member of any preceding or following embodiment/feature/aspect, said method comprising: a) forming a slurry of a composition that comprises the aerogel and first fibrous component, b) pouring the slurry on the mat or second layer in a wet laid process to obtain either the first layer on the second layer or a single layer, and c) drying the first layer and second layer or the single layer.
38. The method of any preceding or following embodiment/feature/aspect, wherein the method further comprises flocculating the slurry prior to step b).
39. Alternatively or in addition, the invention involves a composite insulating structure, comprising:
   a first layer comprising a flexible insulating member of any preceding or following embodiment/feature/aspect; and
   a second layer comprising aerogel and fiber,
   wherein one of the first and second layers comprises 0.5 to 10 wt % of a carbonaceous IR opacifier and the other of the first and second layers comprises less than 0.5 wt % of a carbonaceous IR opacifier, wherein the second layer optionally comprises a flexible insulating member having a different composition than the flexible insulating member of the first layer.
40. The composite insulating structure of any preceding or following embodiment/feature/aspect, wherein the one of the first and second layers comprises 0.5 to 10 wt % of a carbonaceous IR opacifier and the other of the first and second layers has no carbonaceous IR opacifier.
41. The composite insulating structure of any preceding or following embodiment/feature/aspect, wherein the carbonaceous IR opacifier is selected from the group consisting of carbon black, activated carbon, carbon aerogel, carbon xerogel, carbon fibers, reclaimed carbon from pyrolysis of carbon black filled plastic or elastomers, and partially carbonized polymer fibers, and combinations thereof.
42. The composite insulating structure of any preceding or following embodiment/feature/aspect, wherein the carbonaceous IR opacifier is carbon black.
43. The composite insulating structure of any preceding or following embodiment/feature/aspect, further comprising a third layer comprising aerogel and fiber and less than 0.5 wt % of a carbonaceous IR opacifier.
44. The composite insulating structure of any preceding or following embodiment/feature/aspect, wherein the carbonaceous IR opacifier is independently selected for each layer.
45. Alternatively or in addition, the invention involves a series of battery cells, said series comprising a plurality of battery cells electrically connected together and at least a portion of the battery cells are separated from each other by at least one thermal barrier, and said thermal barrier comprising the flexible insulating member of any preceding or following embodiment/feature/aspect.

The invention is further illustrated in the following non-limiting examples.

### EXAMPLES

### Example 1

Experiments were conducted to evaluate the properties and/or performance of several multi-layer flexible insulating members that included a non-woven first layer and a fiber glass mat as the second layer.

Blankets were produced in a wet laid process as described below. One liter of water was mixed with dispersant (Jeffamine M2070, Huntsman), Nalclear 71605 rheology modifier (Nalco) and Foamkill™ 830 defoamer (Crucible Chemical) in a WARING benchtop heavy duty blender and mixed for 10 sec at high shear.

Ceramic fiber (Fiberfrax® 7001 C5 ceramic fiber, Unifrax, a high purity coarsely chopped product having an average fiber diameter of 1.5 to 2.5 microns, and a fiber index of 45-55% measured by conical elutriation), aramid fiber (3 mm, Endnus New Material (Dongguan) Co., Ltd.), glass fiber (E-06-F, Unifrax), P200 aerogel particles (Cabot Corporation), 44 micron rutile titania sand (Loudwolf), F600 6 micron silicon carbide (Sturbridge Metallurgical Services), and aluminum trihydroxide (ATH, Sigma Aldrich), were added to the WARING heavy duty blender in the quantities listed in Table 1. The mixture in the blender was mixed for 20 sec at high shear (15000 rpm) to form a paste-like dispersion. Acrylic binder (Novacryl PSR 300, Synthomer) and silicone binder (Dowsil HV 496 resin, Dow) were added to the blender and mixed for another 20 sec at high shear to make a slurry. The slurry was transferred to a pitcher. To destabilize the slurry system, a flocculant (polydiallyldimethylammonium chloride (PDADMAC) from Sigma Aldrich) was added to the slurry to produce flocs in quantities listed in Table 1. The slurry was then poured over a 7 in round forming wire with a continuous strand veil (FIBREGLAST). The forming wire was then passed over vacuum to remove additional water from the aerogel floc.

The sample was rolled with a metal cylinder to press out some of the water and pack the various components more compactly, then it was dried in an oven at 120° C. for about 15 min. Sample thickness was measured with a thickness gauge.

Thermal conductivity was measured using a LaserComp Heat Flow Meter instrument according to ASTM C518. When the samples were too thin to be measured, they were supported on a shim and the thermal conductivity of the resulting structure (shim+blanket) was determined. The thermal conductivity of the structure was compared to the thermal conductivity measured for the shim alone, to arrive at the thermal conductivity of the blanket itself.

Flammability was measured according to the UL94 standard.

Blankets were made using the following formulation (with all amounts in grams):

TABLE 1

| Ingredients | 1 | 2 | 3 | 4 | 5 | 6 | 7 |
|---|---|---|---|---|---|---|---|
| Water | 1000 | 1000 | 1000 | 3000 | 1000 | 1000 | 1000 |
| Jeffamine M2070 | 0.61 | 0.61 | 0.30 | 1.41 | 0.61 | 0.61 | 0.61 |
| Nalclear 71605 | 0.69 | 0.69 | 0.33 | 1.59 | 0.69 | 0.69 | 0.69 |
| Foamkill 830F | 0.61 | 0.61 | 0.30 | 1.41 | 0.61 | 0.61 | 0.61 |
| AEROGEL P200 | 2.63 | 1.31 | 1.28 | 7.63 | 1.31 | 1.31 | 1.31 |
| Glass Fiber (E-06-F) | 2.63 | 1.32 | 1.28 | | 1.32 | 1.32 | 1.32 |
| Ceramic fiber (C5) | | | | 4.11 | | | |
| Aramid (3 mm) | | | | 0.46 | | | |
| TiO2 (rutile sand) | | | 0.23 | 1.10 | 0.23 | 0.23 | 0.23 |
| SiC | 0.47 | 0.24 | 0.23 | 1.10 | 0.23 | 0.23 | 0.23 |
| ATH | | | 0.07 | 0.35 | 0.07 | 0.07 | 0.07 |
| Novacryl PSR 300 | 0.09 | 0.09 | 0.04 | | 0.09 | 0.00 | 0.09 |
| Joncryl FLX 5201 | | | | 0.40 | | | |
| Dow HV 496 | 0.27 | 0.27 | 0.81 | 1.54 | 0.27 | 0.00 | 0.27 |
| PDADMAC | 0.90 | 0.50 | 0.74 | 2.37 | 0.75 | 0.73 | 0.34 |

These thin blankets achieved good thermal conductivity for their thickness and were considered strong compared to materials made without the second layer. See Table 2.

Tensile strength was determined via an Instron instrument using 2 inch by 6 inch test strips and pulled using the tensile methods set forth by the Instron instrument with a rate of 20 mm/min.

TABLE 2

| | Thermal | | | |
|---|---|---|---|---|
| | Conductivity | Thickness | Tensile Max Load | UL94 V0 |
| Experiment | (mW/m · K) | (mm) | (N) | rating? |
| 1 | 31 | 1.4 | 42 | Yes |
| 2 | 38 | 0.8 | 53 | Yes |
| 3 | 29 | 0.5 | 75 | — |
| 4 | 25 | 1.6 | 40 | Yes |
| 5 | 38 | 0.8 | 32 | Yes |
| 6 | 38 | 0.9 | 47 | Yes |
| 7 | 31 | 0.5 | 75 | Yes |
| Glass Mat | 52 | 0.2 | 9 | No |

The blankets in these examples had good adhesion to the glass web (the second layer). Under UL94 testing, the glass web alone had a flame propagate up the full height of the sample.

These results confirm that aerogel particles can enable the nonwoven blanket to be an excellent thermal barrier for use in Li-ion battery cell or pack and potentially, reduce thermal propagation during a thermal runaway event.

While this invention has been particularly shown and described with references to preferred embodiments thereof, it will be understood by those skilled in the art that various changes in form and details may be made therein without departing from the scope of the invention encompassed by the appended claims.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. It is further understood that for any range provided herein, the numerical ranges can be “about” these ranges, and vice versa, where a range is provided using “about” ranges, these ranges can be precisely the number ranges provided. Any combination of embodiments, and/or ingredients and/or components and/or properties recited herein can be made herein and is considered part of the present invention

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A flexible insulating member comprising a layer that is a mat comprising a second fibrous component, and a pre-formed aerogel and a first fibrous component dispersed in the mat, and said flexible insulating member is non-flammable per UL94 V0 and has a thermal conductivity at 25° C. of less than 40 mW/m·K, and has a thickness of at least 0.3 mm.

2. The flexible insulating member of claim 1, wherein the mat has a thickness and a porosity throughout the thickness, and wherein the aerogel and first fibrous component fills/occupies at least 50% of the porosity throughout at least 90% of the thickness of the mat.

3. (canceled)

4. (canceled)

5. A flexible insulating member comprising:
a first layer comprising aerogel and a first fibrous component, and
a second layer that is a mat comprising a second fibrous component,
wherein the first layer and second layer are affixed together, and said flexible insulating member is non-flammable per UL94 V0 and has a thermal conductivity at 25° C. of less than 40 mW/m·K, and has a thickness of at least 0.3 mm.

6. (canceled)

7. The flexible insulating member of claim 5, wherein the first layer and second layer are affixed together to have a peeling force of at least 0.1 kgf/cm³.

8. (canceled)

9. The flexible insulating member of claim 5, wherein said first layer and said second layer are adhered together by portions of said first layer penetrating or entangling or embedding with portions of the second layer, and/or by chemical adhesion of portions of said first layer with portions of said second layer.

10. (canceled)

11. The flexible insulating member of claim 5, wherein said first layer and said second layer are adhered together in the absence of a separate adhesive layer.

12. (canceled)

13. (canceled)

14. (canceled)

15. (canceled)

16. The flexible insulating member of claim 1, wherein the flexible insulating member has a tensile strength of from about 10 N to 70 N.

17. (canceled)

18. (canceled)

19. (canceled)

20. The flexible insulating member of claim 1, wherein the first layer has an aerogel to first fibrous component weight ratio of from 10:1 to 1:10 as a wet slurry prior to being wet laid.

21. (canceled)

22. The flexible insulating member of claim 1, wherein the mat with the aerogel dispersed therein or the first layer further comprises at least one binder, and has an aerogel to binder weight ratio of from 50:1 to 1:1 as a wet slurry prior to being wet laid.

23. The flexible insulating member of claim 1, wherein the mat with the aerogel dispersed therein or the first layer further comprises at least one flocculant, and has an aerogel to flocculant weight ratio of from 5:1 to 1:1 as a wet slurry prior to being wet laid.

24. The flexible insulating member of claim 1, wherein the mat with the aerogel dispersed therein or the first layer further comprises at least one viscosity modifier, and has an aerogel to viscosity modifier weight ratio of from 5:1 to 1.5:1 as a wet slurry prior to being wet laid.

25. The flexible insulating member of claim 1, wherein the thickness is from 0.3 mm to 20 mm.

26. The flexible insulating member of claim 1, wherein in the mat with the aerogel dispersed therein or the first layer, said aerogel particles by weight are present from 10 wt % to 90 wt %, and said first fibrous component is present from 10 wt % to 90 wt %, based on the dry weight of the mat or the first layer.

27. The flexible insulating member of claim 1, wherein the mat with the aerogel dispersed therein or the first layer further comprises at least one polymer, at least one metal oxide, or at least one inorganic particle that is other than a metal oxide.

28. (canceled)

29. The flexible insulating member of claim 1, wherein the mat with the aerogel dispersed therein or the first layer further comprises at least one IR opacifier.

30. (canceled)

31. (canceled)

32. (canceled)

33. (canceled)

34. The flexible insulating member of claim 1, wherein the aerogel has a caloric content of less than 10 MJ/kg.

35. (canceled)

36. The flexible insulating member of claim 1, wherein the first fibrous component is present in an amount of from 10 wt % to 60 wt % based on the total dry weight of the mat or the first layer.

37. A method of forming the flexible insulating member of claim 1, said method comprising: a) forming a slurry of a composition that comprises the aerogel and first fibrous component, b) pouring the slurry on the mat or second layer in a wet laid process to obtain either the first layer on the second layer or a single layer, and c) drying the first layer and second layer or the single layer.

38. (canceled)

39. A composite insulating structure, comprising:
a first layer comprising a flexible insulating member of claim 1; and
a second layer comprising aerogel and fiber,
wherein one of the first and second layers comprises 0.5 to 10 wt % of a carbonaceous IR opacifier and the other of the first and second layers comprises less than 0.5 wt % of a carbonaceous IR opacifier, wherein the second layer optionally comprises a flexible insulating member having a different composition than the flexible insulating member of the first layer.

40. The composite insulating structure of claim 39, wherein the one of the first and second layers comprises 0.5 to 10 wt % of a carbonaceous IR opacifier and the other of the first and second layers has no carbonaceous IR opacifier.

41. (canceled)

42. (canceled)

43. The composite insulating structure of claim 39, further comprising a third layer comprising aerogel and fiber and less than 0.5 wt % of a carbonaceous IR opacifier.

44. (canceled)

45. A series of battery cells, said series comprising a plurality of battery cells electrically connected together and at least a portion of the battery cells are separated from each other by at least one thermal barrier, and said thermal barrier comprising the flexible insulating member of claim 1.
